(19) United States
(12) Patent Application Publication
(10) Pub. No.: US 2002/0179802 A1
(43) Pub. Date: Dec. 5, 2002

(54) Accessory kit for adjustable hanger

(76) Inventor: George Shandor Hayde, Feldafing (DE)

Correspondence Address: Kajane McManus, P.O. Box 344, Wonder Lake, IL, 60097, US

(21) Appl. No.: 09/871,529

(22) Filed: May 31, 2001

(51) Int. Cl. B60R 1/02; A47G 1/24

(52) U.S. Cl. 248/477; 248/475.1

(57) ABSTRACT

The accessory kit is provided for use with an adjustable hanging system and comprises at least one accessory for engaging a track of the adjustable hanging system for allowing depot and/or wire hanging of an object engaged thereto; at least one accessory for engaging a track of the adjustable hanging system for allowing for transport of an object engaged thereto in a secure and cushioned fashion, or at least one accessory for increasing the distance between the item hung with the hanging system and a supporting surface therefor.

### BACKGROUND OF THE INVENTION

1. Field of the Invention

The present invention relates to an accessory kit for use with an adjustable hanger. More particularly, the accessory kit comprises one accessory for use in depot and/or wire hanging of an item such as a painting, another accessory for transportation thereof, and a further accessory comprising an extender for increasing distance between the hung item and supporting surface therefore.

2. Prior Art

Heretofore, adjustable hanging systems to which the accessory kit of the present invention applies have been disclosed in U.S. Pat. No. 5,878,987 entitled System For Adjustably Mounting An Item to a Vertical Surface and U.S. application Ser. No. 09/499,169 entitled Adjustable Hanging System, the teachings of which are incorporated herein by reference.

As will be best understood upon perusal of this application, the accessory kit of the present invention enhances functionality of the adjustable hanging systems defined above by allowing for accommodation of depot and/or wire hanging and transport of an item to which such adjustable hanger slide kit members are engaged and accommodating any necessary spacing of a hung item from its support.

### SUMMARY OF THE INVENTION

According to the invention there is provided an accessory kit for an adjustable hanging system comprising at least one accessory for engaging a track of the adjustable hanging system for allowing depot and/or wire hanging of an object engaged thereto, at least one accessory for engaging a track of the adjustable hanging system for allowing for transport of an object in a secure and cushioned fashion, or at least one accessory for increasing the distance between the item hung with the hanging system and a supporting surface therefore.

### BRIEF DESCRIPTION OF THE DRAWINGS

FIG. 1 is a perspective view of a hanging system engaging a wire/depot hanging slider accessory of the kit shown in depot hanging form, engaged over a depot crossbrace.

FIG. 2 is a exploded perspective view of one surface of the accessory of FIG. 1.

FIG. 3 is a perspective view of an opposite surface of the accessory of FIG. 1.

FIG. 4 is a cross sectional view through the slider of FIG. 3.

FIG. 5 is a perspective view of an alternate wire hanging accessory shown in wire hanging form.

FIG. 6 is an exploded perspective view of the accessory of FIG. 5 showing one surface of a slider thereof, a connector engageable thereto and a hanging wire loop.

FIG. 7 is a perspective view of another side of the slider of FIG. 6.

FIG. 8 is a top plan view of a wire tensioner of the accessory of FIG. 5, taken along line 8-8 of FIG. 5.

FIG. 9 is a perspective view of a cushioned hanger accessory engaged to a track therefor for use in engaging an item to a supporting surface in a cushioned manner.

FIG. 10 is a perspective view of the accessory of FIG. 9.

FIG. 11 is a perspective view of an extender engaged to a track for use in spacing an item hung by the track from a supporting surface therefor.

FIG. 12 is a perspective view of one embodiment of the accessory of FIG. 11.

FIG. 13 is a perspective view of an alternate embodiment of the accessory of FIG. 11.

### DESCRIPTION OF THE PREFERRED EMBODIMENTS

Referring now to the drawings in greater detail there are illustrated therein a plurality of accessories for use with a hanging system 10 incorporating a track member 12, one or more of the accessories being provided together in the form of an accessory kit for the hanging system 10.

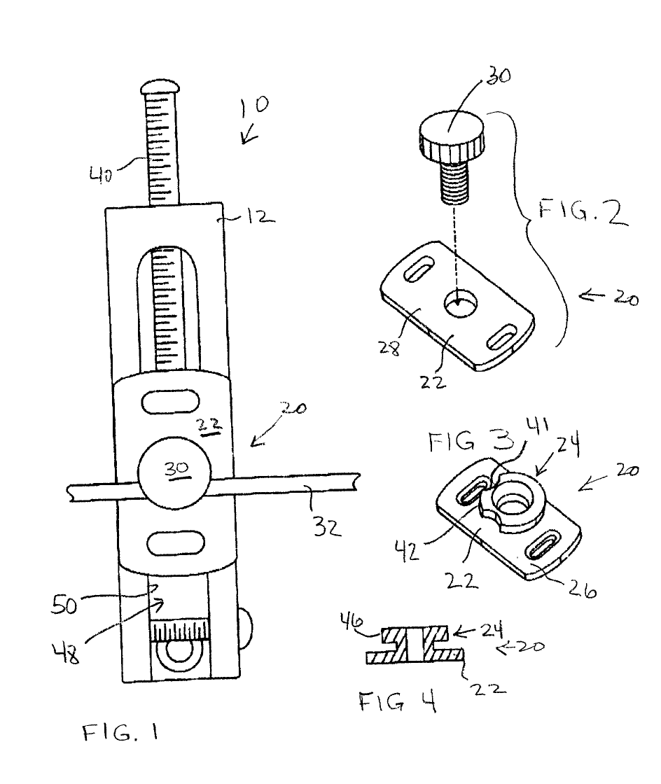

Beginning with FIGS. 1-4, there is illustrated therein the track member 12 of the hanging system 10, the description of which, as stated above is incorporated herein by reference.

A first accessory of the kit 14 for the hanging system 10 is generally identified by reference numeral 20 and comprises a depot hanging accessory 20. As shown, the depot hanging accessory 20 comprises a planar base 22 which has a threaded neck 24 extending to one side 26 thereof. From an opposite side 28 of the planer base 22, a connector 30, such as a bolt 30, engages within the threaded neck 24, extending outwardly from the planar base 22 a distance sufficient to engage over a crossbrace member 32 of a hanging depot (not shown). Relative positioning between the planar base 22 and the hanging system 10 is accomplished through engagement of an end of a movable positioning screw 40 within and against a notch 41 in an exterior surface 42 of the threaded neck 24 which is positioned within the track member 12 of the hanging system 10.

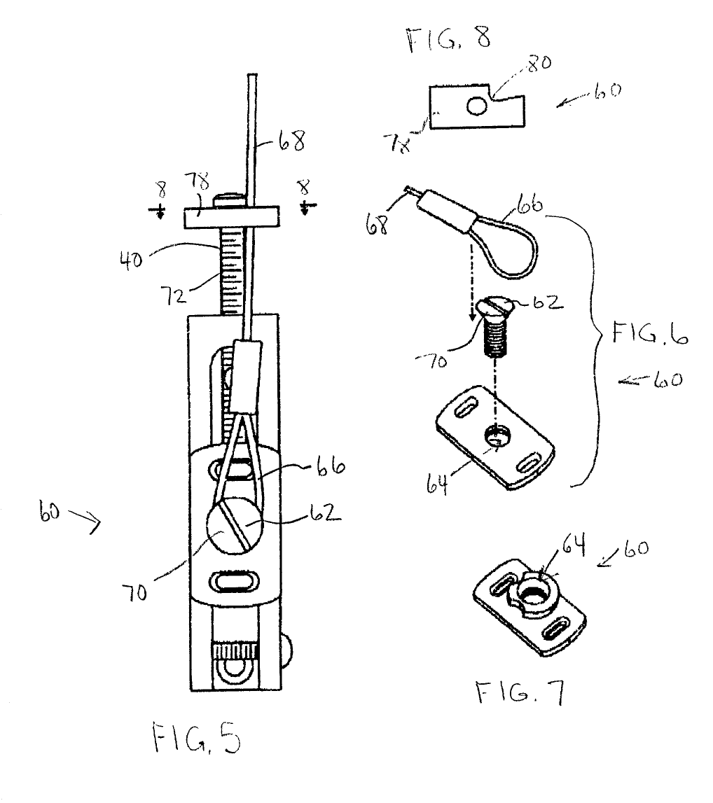

Viewing FIG. 4, it will be understood that the threaded neck 24 has an end flange 46 thereon, with the planar base 22 and the end flange 46 both being wider that the track opening 48 in the track member 12, trapping edge 50 of the track opening 48 therebetween.

Further, as shown in FIGS. 5-8, a similar accessory 60 may be used to accommodate wire hanging. In this respect, a connector 62, such as a screw 62, may be engaged within a threaded neck 64, and a looped end 66 of a hanging wire 68 may be engaged about a head 70 of the screw 62.

Also,in this accessory 60, positioned about a shaft 72 of the positioning bolt 40 is a collar 78 which incorporates a cutout 80 therein to apply pressure against the wire 68 extending downwardly therepast to maintain the looped end 66 of the wire 68 engaged by the head 70 of the screw 62 when the collar 78 is positioned relative to the wire 68 as shown in FIG. 5.

It will be understood that the two accessories 20 and 60 defined above are not mutually exclusive, i.e., they can be replaced by each other if necessary and are primarily presented to show that the embodiments should not be construed as limiting.

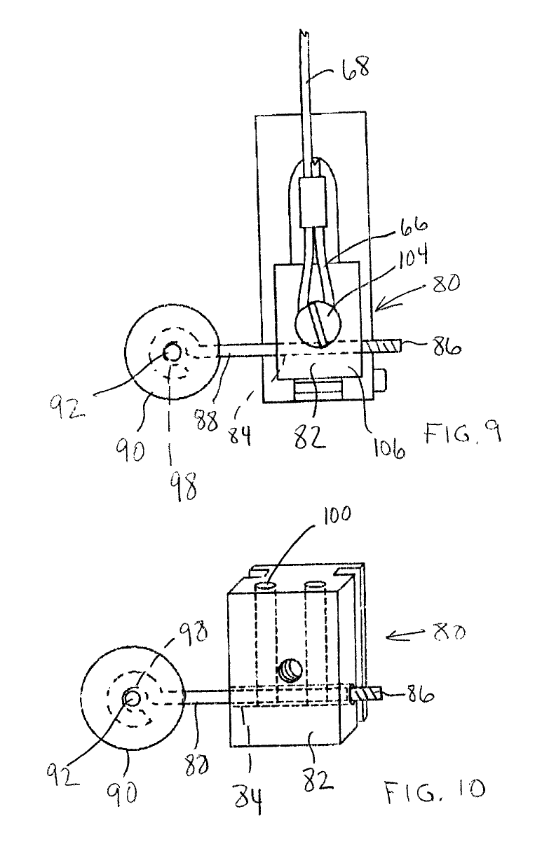

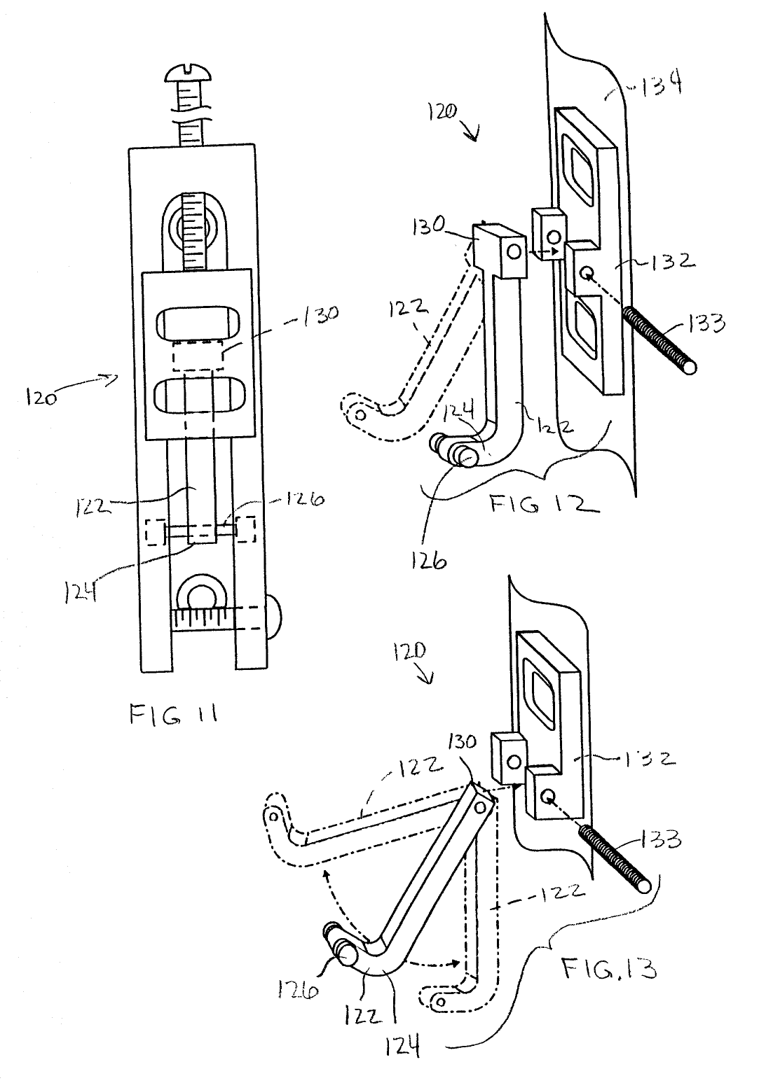

FIGS. 9 and 10 illustrate another accessory 80 primarily provided for use in easing the rigors, an object, such as a work of art, goes through during transport thereof. In this respect, the accessory 80 comprises a slide 82 engageable to and within the track 48 of the track member 12, the slide 82 incorporating a horizontal throughbore 84 within which a threaded end 86 of an eyehook 88 is engaged. The eyehook 88 has a cushion 90 engaged thereto and therearound, with the cushion having a center bore 92 therein which is provided within the inner margin 98 of the eyehook 88. When the accessory 80 is engaged and oriented as shown in FIG. 9, passage of a suitable connector (not shown) through the center bore 92 of the cushion 90 will engage the eyehook 88 to a support surface, such as a wall securing the accessory 80 and engaged track member 12 to the support surface, in a manner interposing the cushion 90 between the eyehook 88 and the supporting surface, cushioning the “ride” of the object engaged to the track member 12.

It will be seen that the slide 82 also incorporates at least one vertical bore 100 therein within which the threaded end 86 of the eyehook 88 may be engaged for storage thereof, when not in use. Further, the slide 82 includes a removable connector 104 engaged to a surface 106 thereof directed away from the track member 12 for use in engaging the loop 66 of hanging wire 68 thereto if it is desired to do so. Thus, the accessory 80 accommodates objects which may or may not be wire hung.

Turning now to a final accessory 120, this will be defined as an extender accessory 120 which comprises an arm 122 having a hooked end 124 which has a crossmember 126 extending laterally outwardly thereof, the crossmember 126 pivotably engaging within the track member 12 in the manner illustrated in FIG. 11 with the arm 122 being dimensioned to extend through the opening 48 in the track member 12, the crossmember 126 also acting as a slide 126 within the track member 12.

An opposite straight end 130 of the arm 122 is pivotably engaged to a base plate 132 by a connector 133 which engages a support surface 134 such as a wall 134, with pivotability of the arm 122 at both ends 124 and 130, together with slidability of the end 124 relative to and within the track member 12, allowing for varied angulation and thus varied spacing, between the supporting surface 134 and the object engaged to the track member 12, as shown in FIGS. 12 and 13.

It will be understood that one, two, three, or all four accessories described above may be provided in the accessory kit, as desired by the user of the hanging system 10. Also, although only one of each accessory has been illustrated for the sake of brevity, it will be understood that it is preferred, although not mandatory, that the accessories be used in pairs; one being positioned at each upper corner of an object, such as a frame.

As described above, the accessory kit of the present invention provides a number of advantages, some of which have been described above and others of which are inherent in the invention. Also, modifications may be proposed to the kit as well as component structures thereof without departing from the teachings herein. Accordingly, the scope of the invention is only to be limited as necessitated by the accompanying claims.

1. An accessory kit for use with a hanging system comprising at least a track member having a track therein, the kit comprising at least one of a first accessory engageable to and within said track of said track member and including a hanging wire engaging connector thereon; at least one of a second accessory engageable to and within said track of said track member and including a hanging depot crossbrace engaging connector thereon; at least one of a third accessory engageable to and within said track of said track member and including a cushioned connector extending therefrom by an arm, the cushioned connector having a throughbore therein within and through which a threaded connector is engaged; or, at least one of a fourth accessory engageable to and within said track of said track member by one end of a pivotable arm, the accessory further including a mountable base pivotably engaged to another end of the pivotable arm.
